(19) United States
(12) Patent Application Publication
(10) Pub. No.: US 2003/0064628 A1
(43) Pub. Date: Apr. 3, 2003

(54) Universal pressed screen for various connector designs

(76) Inventors: Klaus Kaiser, Markgroeningen (DE); Markus Michels, Stuttgart (DE)

Correspondence Address: KENYON & KENYON, ONE BROADWAY, NEW YORK, NY, 10004, US

(21) Appl. No.: 10/188,218

(22) Filed: Jul. 2, 2002

(30) Foreign Application Priority Data
Jul. 7, 2001 (DE) 201 11 337.6

(51) Int. Cl. H01R 24/00

(52) U.S. Cl. 439/660

(57) ABSTRACT

A multipole electrical plug connector which is provided with a mating connector for a disconnectable connection having essentially one or more contact elements (3), as well as electrical strip conductors (2) which lead to the contact elements (3), and which jointly form a pressed screen (1) designed as a one-piece part, the strip conductors (2) at their free ends being provided with receptacles (5), into which contact elements (3) may be plugged in.

Due to a single flexibly designed pressed screen (1) having appropriate receptacles (5) it is possible to cost-effectively manufacture various plug connectors having different contact element arrangements.

The invention relates to a multipole electrical plug connector which is provided with a mating connector for a disconnectable connection having essentially one or more contact elements, as well as electrical strip conductors which lead to the contact elements and which jointly form a pressed screen designed as a one-piece part.

### BACKGROUND INFORMATION

Plug connectors of the kind mentioned above are already known in innumerable designs. They have a plurality of contact elements which are positioned in multiple rows, as well as side by side. In particular plug connectors having a pressed screen—which means that the individual strip conductors leading to the contact elements are punched out of strip conductor sheet metal—are, as a rule, embedded in or injected into a plastic carrier. The contact elements jointly with the strip conductors are also punched out of strip conductor sheet metal, and are subsequently appropriately bent in an additional manufacturing process.

### DISADVANTAGES OF THE RELATED ART

Due to the fact that the contact elements and the strip conductors are manufactured together in one punching operation, it is necessary to make the material thickness of the strip conductors equal to the thickness of the contact elements. Thus, the material thickness of the strip conductor is overdimensioned. It is also necessary to manufacture a separate punching tool for each contact element design. This means that for different configurations of a plug connector, different punching tools must be available.

### OBJECT OF THE PRESENT INVENTION

The object of the present invention is to create a plug connector by using one pressed screen which is usable universally.

### ACHIEVING THE OBJECT

The present invention pursues the path of manufacturing a universally usable pressed screen in one operation the pressed screen being suitable for a plurality of positioning possibilities of contact elements. As a function of the appropriate assembly diagram of the contact elements, one or more receptacles, provided at the free ends of the strip conductors, may optionally be assigned to the contact elements.

### ADVANTAGES OF THE PRESENT INVENTION

The essence and advantage of the present invention is the fact that a single pressed screen is adjustable to various connector designs, i.e., different arrangements of the contact elements. The contact elements necessary for the particular plug connector are plugged into the receptacles and fixedly attached by turning; the receptacles may be in the form of a through-hole, for example, having a rectangular cross-section. The unit, including the pressed screen or the strip conductor, together with the contact elements, is extrusion coated in an additional operation using plastic, so that the contact elements are fixedly joined with the particular strip conductors.

In contrast to the variations known from the related art, a considerable cost advantage results from the fact that only a small number of punching tools is necessary in order to manufacture a plurality of connector designs.

An additional advantage of the present invention is the reduction of the material thickness of the pressed screen, since it is not bound to the material thickness of the contact elements. This entails a cost advantage with regard to a lower material usage.

Another advantage of the present invention is the fact that the contact elements are treatable before they are joined with the pressed screen. The contact elements are advantageously treated by using a cost-effective drum coating method. Since, according to the related art, strip conductor and contact elements have a one-piece design, it was necessary to run the finished component through a treatment bath. Since the strip conductors are also treated in this way, more coating material is used as is necessary per se.

Additional advantageous embodiments are derived from the following description, the claims, and the drawing.

### DRAWING

FIG. 1 shows a perspective view of the pressed screen according to the present invention having a first possible arrangement of contact elements;

FIG. 2 shows a perspective view of the pressed screen according to FIG. 1 having an additional possible arrangement of contact elements;

FIG. 3 shows a perspective view of the pressed screen according to FIG. 1 having another possible arrangement of contact elements.

### DESCRIPTION OF THE EXEMPLARY EMBODIMENTS

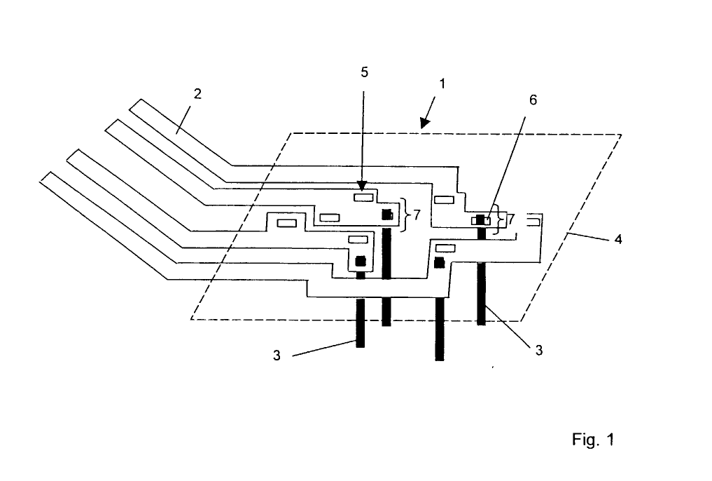

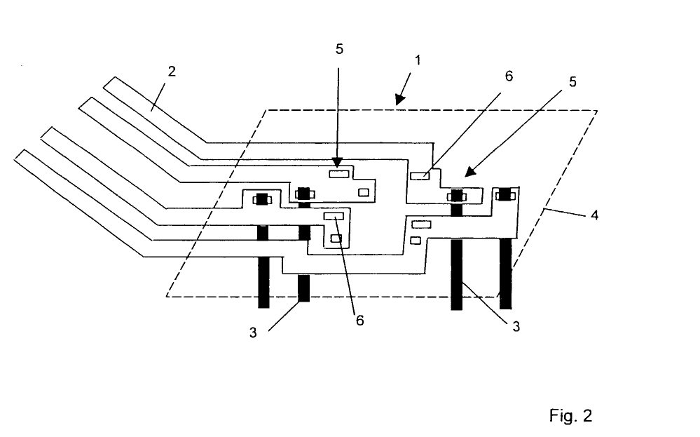

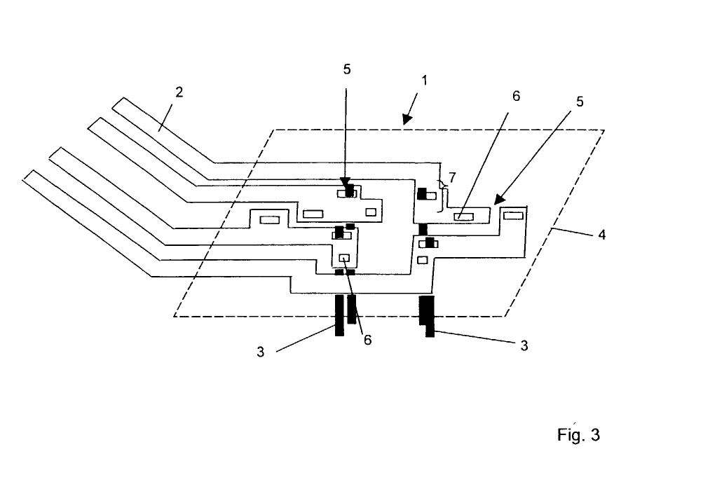

The same pressed screen 1, including different strip conductors 2, is illustrated in FIGS. 1 through 3. Strip conductors 2 end, with one side closed, at a connector element (not shown in greater detail), the additional free ends, depending on the possible arrangement of contact elements 3, ending in a defined plane 4 and having receptacles 5 at their free ends.

Receptacles 5 include rectangularly formed through-holes 6, which are provided for receiving contact elements 3, which are preferably designed as plug-in pins.

The fastening of contact elements 3 to receptacles 5 may be implemented by twisting part 7 which protrudes from through-hole 6. By extrusion coating pressed screen 1 in its pre-assembled state, a final fastening of contact elements 3 is achieved with regard to pressed screen 1.

Due to a single flexibly designed pressed screen 1 which has appropriate receptacles 5 it is possible to cost-effectively manufacture a variety of connectors having different contact element arrangements.

What is claimed is:

1. A multipole electrical plug connector, which is provided with a mating connector for a disconnectable connection, comprising essentially one or more contact elements, as well as electrical strip conductors which lead to the contact elements and which jointly form a pressed screen designed as a one-piece part,
wherein the strip conductors (2) at their free ends are provided with receptacles (5), into which contact elements (3) may be plugged in.

2. The plug connector as recited in claim 1,
wherein the receptacles (5) are designed as through-holes (6), into which the contact elements (3) are introducible and are lockable by a defined turn.

3. The plug connection as recited in claim 2,
wherein the cross-section of the through-hole (6) has a rectangular design.

4. The plug connector as recited in at least one of the preceding claims,
wherein the contact elements (3) are welded to the strip conductors (2).

5. The plug connector as recited in at least one of the preceding claims,
wherein the contact elements (3) are soldered to the strip conductors (2).

6. The plug connector as recited in at least one of the preceding claims,
wherein the contact elements (3) are riveted to the strip conductors (2).
